(19) United States
(12) Patent Application Publication
(10) Pub. No.: US 2013/0071235 A1
(43) Pub. Date: Mar. 21, 2013

(54) LIGHT WEIGHT ABRADABLE AIR SEAL

(71) Applicants: Christopher W. Strock, Kennebunk, ME (US); George H. Reynolds, Sanford, ME (US)

(72) Inventors: Christopher W. Strock, Kennebunk, ME (US); George H. Reynolds, Sanford, ME (US)

(21) Appl. No.: 13/236,926

(22) Filed: Sep. 20, 2011

(51) Int. Cl. F01D 11/12; B05D 1/36; F16J 15/44

(52) U.S. Cl. 415/174.4; 277/415; 427/201

(57) ABSTRACT

An air seal for use with rotating parts includes an abradable layer adhered to a substrate. The abradable layer comprises a matrix of agglomerated hexagonal boron nitride and an oxide ceramic. Another hexagonal boron nitride is interspersed with the matrix.

### BACKGROUND OF THE INVENTION

This disclosure relates to an air seal for a gas turbine engine.

In compressor and turbine sections of a gas turbine engine, air seals are used to seal the interface between rotating structure, such as a hub or a blade, and fixed structure, such as a housing or a stator. For example, typically, circumferentially arranged blade seal segments are fastened to a housing, for example, to provide the seal.

Relatively rotating components of a gas turbine engine are not perfectly cylindrical or coaxial with one another during engine operation. As a result, the relatively rotating components may occasionally rub against one another. To this end, an abradable material typically is adhered to the blade seal segments and/or the rotating component.

### SUMMARY

An air seal for use with rotating parts includes an abradable layer adhered to a substrate. The abradable layer comprises a matrix of agglomerated hexagonal boron nitride and an oxide ceramic. Another hexagonal boron nitride is interspersed with the matrix.

These and other features of the present invention can be best understood from the following specification and drawings, the following of which is a brief description.

### BRIEF DESCRIPTION OF THE DRAWINGS

FIG. 1 shows a perspective view of a portion of a gas turbine engine incorporating an air seal.

FIG. 2 shows a schematic view of an air seal.

### DETAILED DESCRIPTION OF THE PREFERRED EMBODIMENT

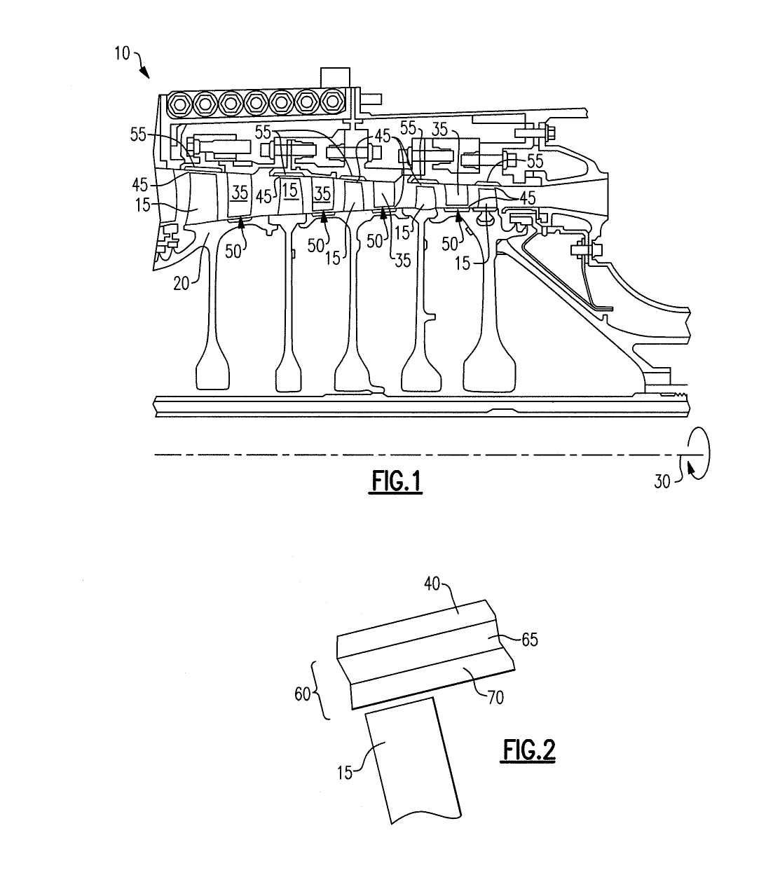

FIG. 1 shows a portion of a gas turbine engine 10, for example, a high pressure compressor section. The engine 10 has blades 15 that are attached to a hub 20 that rotate about an axis 30. Stationary vanes 35 extend from a substrate 40, such as an outer case or housing, and are circumferentially interspersed between the turbine blades 15, which may be constructed from titanium in one example. A first gap 45 exists between the blades 15 and the substrate 40, and a second gap 50 exists between the vanes 35 and the hub 20.

Air seals 60 (FIG. 2) are positioned in at least one of the first and second gaps 45, 50. Further, the air seals 60 may be positioned on: (a) the outer edge of the blades 15; (b) the inner edge of the vanes 35; (c) an outer surface of the hub 30 opposite the vanes 35; and/or (d) as shown in FIG. 2, on the inner surface of outer case opposite the blades 15. It is desirable that the gaps 45, 50 be minimized and interaction between the blades 15, vanes 35 and seals 60 occur to minimize air flow around blade tips or vane tips. It should be recognized that the seal provided herein may be used in any of a compressor, a fan or a turbine section and that the seal may be provided on rotating or non-rotating structure.

In one example shown in FIG. 2, the air seal 60 includes an abradable layer 70 supported on the substrate 40, which may be constructed from a nickel alloy, by a bond coat 65. The bond coat 65 may include a nickel alloy, platinum, gold, silver, or MCrAlY, wherein M includes at least one of nickel, cobalt, iron or a combination thereof.

The abradable layer consists of three ceramic materials, which have different material characteristics from one another, such as chemical composition and/or particle size. The abradable layer is a bimodal mix of a first ceramic material of an oxide ceramic (for example, stable up to at least 1200° F. (650° C.)) and second ceramic material of hexagonal boron nitride (“hBN”), and inclusions of a third ceramic material of larger hBN. No metallic material is used in the abradable layer, which greatly reduces its weight, for example, by around 30%. The abradable layer has a strength of at least 500 psi (3.5 MPa).

Feed stock used to provide the air seal 60 is made of oxide ceramic and hBN held together with a binder, plus hBN particles that are used at a variable ratio to the agglomerated composite powder to adjust and target the coating properties during manufacture. One of ordinary skill in the art will recognize that other compounds, such as a relatively soft ceramic like bentonite clay, may be substituted for the hBN.

The matrix of oxide ceramic and hexagonal boron nitride (hBN) includes hBN particles in the range 1-10 micron particle sizes and the oxide ceramic in the range of 1-45 micron particle size. Polyvinyl alcohol or bentonite may be used as a binder to agglomerate the oxide ceramic and hBN before thermal spraying. Larger particles of hBN are added to the fine composite matrix prior to spraying or during spraying. The larger hBN particles are in the range of 15-100 microns particle size, though 20-75 microns particle size may be typical.

The amount by volume of oxide ceramic in the abradable layer is about 25-45% with the matrix composite of oxide ceramic and hBN having a volume fraction of about 35-50% oxide ceramic. The amount by volume of porosity is about 5-15% of the abradable layer. The larger hBN particles make up the remainder of the coating, the total amount by volume of hBN in the abradable layer is 30-50% with up to 15% of the volume percent comprising the binder. In one example, the oxide ceramic is at least one of aluminum-, zirconium- and titanium-based.

In a first example, the oxide ceramic is a mix of aluminum oxide (Al₂O₃) and titanium dioxide (TiO₂). This titanium dioxide improves cracking and spallation resistance of the oxide ceramic. The mix includes 0-15% by weight of titanium dioxide. One desired mix is 87 wt % aluminum oxide/13 wt % titanium dioxide, and another desired mix is 97 wt % aluminum oxide/3 wt % titanium dioxide.

In a second example, the oxide ceramic includes about 7% by weight yttrium stabilized zirconia (YSZ).

The powders are deposited by a known thermal spray process, such as high velocity oxygen fuel spraying (HVOF), combustion flame spray or air plasma spray (APS). Fine particle-sized hBN powders and the fine particle-sized oxide ceramic powders being pre-agglomerated as described, are deposited on the substrate by thermal spray. The larger particle-sized hBN particles may be added to the agglomerates as a particle blend and delivered to the spray apparatus pre-blended, or may be delivered to the spray apparatus through a separate delivery system. However, it is also possible to include the larger hBN particles in the agglomerates of matrix material.

Typically, the matrix of agglomerated hBN powder and oxide ceramic powder and the larger hBN powder are fed into the plasma plume from separate powder feeders. The abradable layer 70 is deposited onto the substrate 40 (or bond coat 65) to a desired thickness, for example, 15-150 mils (0.38-3.81 mm), and in one example, 80 mils (2.03 mm).

Although an example embodiment has been disclosed, a worker of ordinary skill in this art would recognize that certain modifications would come within the scope of the claims. For that reason, the following claims should be studied to determine their true scope and content.

What is claimed is:

1. An air seal for use with rotating structure in a gas turbine engine comprising:
a substrate; and
an abradable layer adhered to the substrate, the abradable layer comprising:
a matrix of agglomerated hexagonal boron nitride and an oxide ceramic, and
a hexagonal boron nitride, wherein the hexagonal boron nitride is interspersed with the matrix.

2. The air seal according to claim 1, wherein the substrate is metallic, and comprising a bond coat arranged between and interconnecting the substrate and the abradable layer.

3. The air seal according to claim 1, wherein the amount by volume of the oxide ceramic in the abradable layer is about 25-45%, and the amount by volume of porosity is about 5-15% of the abradable layer.

4. The air seal according to claim 3, wherein the oxide ceramic is stable up to at least 1200° F. (650° C.).

5. The air seal according to claim 4, wherein the oxide ceramic is at least one of aluminum-, zirconium- and titanium-based.

6. The air seal according to claim 5, wherein the oxide ceramic is a mix of aluminum oxide and titanium dioxide.

7. The air seal according to claim 6, wherein the mix includes 0-15% by weight of titanium dioxide.

8. The air seal according to claim 5, wherein the oxide ceramic includes about 7% by weight yttrium stabilized zirconia.

9. The air seal according to claim 4, wherein the abradable layer is without a metallic material and has a strength of at least 500 psi (3.5 MPa).

10. The air seal according to claim 4, wherein the hexagonal boron nitride comprises particles of 1-10 microns agglomerated with the oxide ceramic which comprises particles of—1-45 microns, and the hexagonal boron nitride comprises particle of 15-100 microns.

11. The air seal according to claim 1, wherein the abradable layer has a thickness of about 80 mils (2.03 mm).

12. A gas turbine engine comprising:
a first structure;
a second structure rotating relative to the first structure, wherein one of the first and second structures provides a substrate; and
an abradable layer adhered to the substrate, the abradable layer comprising:
a matrix of agglomerated hexagonal boron nitride and an oxide ceramic, and
an hexagonal boron nitride, wherein the hexagonal boron nitride is interspersed with the matrix.

13. A method of manufacturing a gas turbine engine air seal comprising:
depositing an abradable coating onto a substrate, the abradable coating including
agglomerating a matrix of hexagonal boron nitride powder and a oxide ceramic powder, and
mixing with the matrix a hexagonal boron nitride powder.

14. The method according to claim 13, wherein the amount by volume of oxide ceramic in the abradable layer is about 25-45%, and the amount by volume of porosity is about 5-15% of the abradable layer, the oxide ceramic is a mix of aluminum oxide and titanium dioxide, and the mix includes 0-15% by weight of titanium dioxide.

15. The method according to claim 13, wherein the amount by volume of the oxide ceramic in the abradable layer is about 25-45%, and the amount by volume of porosity is about 5-15% of the abradable layer, the oxide ceramic includes about 7% by weight yttrium stabilized zirconia.
